(19) United States
(12) Patent Application Publication
(10) Pub. No.: US 2015/0257420 A1
(43) Pub. Date: Sep. 17, 2015

(54) BUCKWHEAT PUDDING COMPOSITIONS AND METHODS OF MAKING THE SAME

(71) Applicant: Irina Zlatkina, Baltimore, MD (US)

(72) Inventor: Irina Zlatkina, Baltimore, MD (US)

(21) Appl. No.: 14/598,001

(22) Filed: Jan. 15, 2015

Related U.S. Application Data
(60) Provisional application No. 61/927,937, filed on Jan. 15, 2014.

(51) Int. Cl. A23L 1/187

(52) U.S. Cl. CPC A23L 1/1875; A23V 2002/00

(57) ABSTRACT

Disclosed are Buckwheat Pudding Compositions and Methods of making Buckwheat Pudding Compositions. The disclosed compositions and methods provide the first blended, homogeneous pudding compositions comprising cooked buckwheat. The methods provide the first means for attaining such compositions. The disclosed compositions and methods provide health and flavor benefits beyond any other food compositions prior to this disclosure.

### CROSS REFERENCE TO RELATED APPLICATIONS

This application claims the benefit of U.S. Provisional Patent Application No. 61/927,937, filed on Jan. 15, 2014.

### BACKGROUND

Pudding compositions have been known for hundreds of years. The original pudding was formed by mixing various ingredients with a grain product or other binder such as butter, flour, cereal, eggs, and/or suet, resulting in a solid mass. These puddings are baked, steamed or boiled.

Depending on its ingredients, such a pudding may be served as a part of the main course or as a dessert.

Boiled or steamed pudding was a common main course aboard ships in the Royal Navy during the 18th and 19th centuries. Pudding was used as the primary dish in which daily rations of flour and suet were prepared.

Within the pudding arts, one important subset are the dessert pudding compositions, such as chocolate pudding. There are two main types: (1) a boiled then chilled, texturally a custard set with starch, version commonly eaten in the U.S., Canada, Sweden, and East and South East Asia; and (2) a steamed/baked, texturally similar to cake, version that is popular in the UK, Ireland, Australia, and New Zealand.

The former, custard-like puddings often use starch as a thickener. Early versions of the dish using both egg and flour can be found in the 1918 edition of Fannie Farmer's Boston Cooking School Cook Book and in the 1903 edition of Mary Harris Frazer's Kentucky Receipt Book.

Modern puddings are usually made with milk and sugar, flavored with agents (e.g., chocolate and vanilla) and thickened with a starch such as flour or cornstarch. Occasionally, eggs are still used when making chocolate pudding. Usually it is cooked together on the stovetop, but other heating methods exist including microwaving, steaming, baking (sometimes in a bain-marie) or freezing (using gelatin as a thickener). Pudding is commonly purchased ready-made in stores.

Despite the long history and widespread acclaim of pudding compositions, the art has not prepared a cooked Buckwheat pudding. Cream of buckwheat has been prepared. And artisans have explored incorporating raw buckwheat into a variety of food compositions. But, the culinary arts have never prepared a smooth, texturally homogeneous cooked Buckwheat pudding.

Furthermore, the culinary arts have never prepared a vegan, gluten-free, and texturally homogeneous, cooked Buckwheat pudding. Buckwheat offers many advantages over other forms of starch and flour. Buckwheat provides numerous nutritional and flavor advantages. Additionally, the present day cuisine has demonstrated an increasing need for allergen free, vegan food products.

Disclosed herein are buckwheat pudding compositions and methods of making the same. The disclosed pudding compositions provide both health and flavor benefits beyond the existing state of the art.

### DETAILED DESCRIPTION

Disclosed herein are Pudding compositions comprising Buckwheat and a Thickener, Methods of making Buckwheat Pudding compositions, and products produced by milling Buckwheat, Heating Buckwheat, Combining Buckwheat with Thickener, and blending the mixture.

Disclosed herein is a Pudding composition comprising Buckwheat and a Thickener.

As used herein, the term Pudding means a food composition having a homogeneous, thick, smooth, and viscous consistency. A Pudding composition could exist as suspension or dispersion. Often a Pudding composition is described as having a soft, smooth mouthfeel.

In the culinary arts, the term pudding is frequently used to describe a sweetened usually cooked dessert made in many forms and of various ingredients, such as flour, milk, and eggs, with fruit, etc. The Pudding compositions disclosed herein differ from all existing compositions and provided significant benefits beyond the state of the art pudding compositions.

The Pudding compositions disclosed herein comprise Buckwheat, such as cooked Buckwheat. In one example, cooked Buckwheat can be attained by boiling milled buckwheat in water for about 15 to 25 minutes. In one embodiment, the Pudding compositions comprising cooked buckwheat are smooth, blended, homogeneous compositions.

As used herein, the term Buckwheat means the seeds of the plant species Fagopyrum esculentum.

In one embodiment, the Buckwheat is Milled Buckwheat.

As used herein, the term Milled Buckwheat means buckwheat that has been mechanically crushed or ground into a granular powder.

In addition to Buckwheat, the Pudding compositions of this disclosure comprise a Thickener.

As used herein, the term Thickener means a substance that increases the viscosity of a solution without modifying its other properties.

In one embodiment, the Thickener is chosen from gum acacia and xanthan gum. In one embodiment, the Thickener is a mixture of starch powder and water. In one embodiment, the Thickener is a mixture of a starch powder and water in about 1 1:20 to 1:30 ratio of starch powder to water. In one embodiment, the Thickener is a starch custard having 1 part starch powder and 24 parts water by weight.

As used herein, the term xanthan gum means the polysaccharide secreted by the bacterium Xanthomonas campestris, often used to refer to pentasaccharide repeat units, comprising glucose, mannose, and glucuronic acid in the molar ratio 2.0:2.0:1.0.

As used herein, the term gum acacia means a natural gum made of hardened sap taken from two species of the acacia tree; Senegalia (Acacia) senegal and Vachellia (Acacia) seyal.

In one embodiment, the Pudding compositions disclosed herein comprise a Thickener chosen from gum acacia or xanthan gum in a proportion of about 1-4% by mass. In another embodiment, the Pudding compositions disclosed herein comprise a Thickener chosen from gum acacia or xanthan gum in about 2% by mass.

In one embodiment, the Pudding compositions disclosed herein comprise an essential amino acid chosen from phenylalanine, valine, threonine, tryptophan, isoleucine, methionine, leucine, lysine, and histidine. In another embodiment, the Pudding composition disclosed herein comprise each of phenylalanine, valine, threonine, tryptophan, isoleucine, methionine, leucine, lysine, and histidine.

In one embodiment, the Pudding compositions disclosed herein comprise Salicylaldehyde (2-hydroxybenzaldehyde).

In one embodiment, the Pudding compositions disclosed herein comprise 2,5-dimethyl-4-hydroxy-3(2H)-furanone.

In one embodiment, the Pudding compositions disclosed herein comprise (E,E)-2,4-decadienal, phenylacetaldehyde, 2-methoxy-4-vinylphenol.

In one embodiment, the Pudding compositions disclosed herein comprise (E)-2-nonenal.

In one embodiment, the Pudding composition disclosed herein comprises decanal.

In one embodiment, the Pudding compositions disclosed herein comprise hexanal.

In one embodiment, the Pudding compositions disclosed herein comprise Salicylaldehyde (2-hydroxybenzaldehyde), 2,5-dimethyl-4-hydroxy-3(2H)-furanone, (E,E)-2,4-decadienal, phenylacetaldehyde, 2-methoxy-4-vinylphenol, (E)-2-nonenal; decanal, and hexanal.

In one embodiment, the Pudding compositions disclosed herein comprise Fagopyritol A1.

In one embodiment, the Pudding compositions disclosed herein comprise Fagopyritol A2.

In one embodiment, the Pudding compositions disclosed herein comprise Fagopyritol B1.

In one embodiment, the Pudding compositions disclosed herein comprise Fagopyritol B2.

In one embodiment, the Pudding compositions disclosed herein comprise Fagopyritol B3.

In one embodiment, the Pudding compositions disclosed herein comprise each of Fagopyritol A1, Fagopyritol A2, Fagopyritol B1, Fagopyritol B2, and Fagopyritol B3.

In one embodiment, the Pudding composition disclosed herein comprises rutin.

In one embodiment of the Pudding compositions disclosed herein, the Thickener is starch.

In one embodiment, the Pudding compositions disclosed herein comprise arrowroot starch. As used herein, the term arrowroot starch means a fine-grained starch extracted from the underground parts of various tropical plants, especially of the genus Maranta of the family Marantaceae.

In one embodiment, the Pudding compositions disclosed herein comprise coconut oil.

As used herein, the term coconut oil means the oil extracted from the kernel or meat of matured coconuts harvested from the coconut palm (Cocos nucifera).

In one embodiment, the Pudding composition disclosed herein is substantially free from gluten. As used herein, the term gluten means the composite of a gliadin and a glutenin, which is conjoined with starch in the endosperm of various grass-related grains.

As used herein, the term “substantially free from gluten” means less then 30 parts per million gluten in the Pudding composition. In at least one embodiment, the Pudding composition substantially free from gluten comprises less then 20 parts per million gluten.

In one embodiment, the Pudding composition disclosed herein is substantially free from dairy. As used herein, the term dairy means products derived from the milk of mammals. As used herein the term “substantially free from dairy” means not including dairy or dairy products, such as milk, cheese, milk fat, cream, or any derivatives thereof.

In one embodiment, the Pudding composition disclosed herein is substantially free from animal-derived substances. As used herein the term “animal derived substances” means any material of animal origin. The term “vegan” is often used to describe compositions that are free from animal derived products. Notably, the term “substantially free from animal-derived substances” would also include compositions having essentially no milk or milk product.

In one embodiment, the Pudding composition disclosed herein is substantially free from soy. As used herein, the term “soy” means protein isolates of the species Glycine max. As used herein, the term “substantially free from soy” means containing no soy, soy-based ingredients, soy extracts, or soy products.

In one embodiment, the Pudding composition disclosed herein is homogeneous. As used herein, the term “homogeneous” means of uniform composition and texture.

In one embodiment, the Pudding composition disclosed herein comprises sugar. As used herein the term sugar means a sweet-tasting carbohydrate, generally of the molecular formal CnH2nOn, where n is positive integer. In one embodiment the Pudding compositions comprise glucose.

In one embodiment, the Pudding composition disclosed herein comprises a sugar composition comprising a mineral chosen from calcium, magnesium, potassium, and iron. For example, in one embodiment, the disclosed Pudding compositions comprise sucanat as a natural sugar composition.

In one embodiment, the Pudding composition disclosed herein comprises a natural flavoring agent. As used herein, the term “natural flavoring agent” means the essential oil, oleoresin, essence or extractive, protein hydrolysate, distillate, or any product of roasting, heating or enzymolysis, which contains the flavoring constituents derived from a spice, fruit or fruit juice, vegetable or vegetable juice, edible yeast, herb, bark, bud, root, leaf or any other edible portions of a plant or fermentation products thereof, whose primary function in food is flavoring rather than nutritional.

In one embodiment, the flavoring agent is cocoa. As used herein, the term “cocoa” means a powder made from roasted, husked, and ground seeds of the cacao plant, Theobroma cacao, from which much of the fat has been removed. In one embodiment, the cocoa powder is dairy free.

In one embodiment, the flavoring agent is pistachios. As used herein, the term “pistachios” means the seed of the tree species Pistacia vera.

In one embodiment, the flavoring agent is vanilla. As used herein, the term “vanilla” means flavor derived from extracts (e.g., the compound vanillin) of a plant of the genus Vanilla.

Also disclosed herein is a method of making pudding comprising: heating an aqueous mixture of Milled Buckwheat in water; heating Thickener in water; Combining Milled Buckwheat with Thickener; and Blending.

As used herein, the term “heating” means increasing the temperature of the substance by applying heat. In one embodiment, applying heat includes placing a container having a 5:1 ratio of water:Milled Buckwheat on a flame or electric burner or heating element and allowing the temperature of the 5:1 ratio of water:Milled Buckwheat to increase. In one embodiment, the temperature of the 5:1 ratio of water:Milled Buckwheat is increased to about 100° C.

As used herein, the term “Combining” means adding the substances together in physical space, so that they contact one another. In one example, “Combining” water with Milled Buckwheat includes pouring Milled Buckwheat into a water, thereby Combining the Buckwheat with the water.

As used herein, the term “heating Thickener in water” means adding the Thickener to water and applying heat to the mixture of those two ingredients.

As used herein, the term “Blending” means mechanically mixing and/or homogenizing materials to obtain a mass of a particular character, quality, or consistency. In one embodiment, the Blending comprises blending the mixture of Milled Buckwheat, water, and Thickener for between 3 to 8 minutes. In one embodiment, Blending includes placing cooked cream of buckwheat, Thickener, and flavor in an industrial mixer and beating the contents of the mixer until the resulting composition is consistent and smooth.

In one embodiment, the method of making pudding comprises heating an aqueous mixture of Milled Buckwheat in water at a temperature of above 90° C.

In one embodiment, the method of making pudding comprises heating an aqueous mixture of Milled Buckwheat in water at a temperature of about 100° C.

In one embodiment, the method of making pudding comprises heating an aqueous mixture of Milled Buckwheat in water at a temperature of about 100° C. for a time of about 15 to 25 minutes.

In one embodiment, the method of making pudding comprises Blending until the combination of Milled Buckwheat and Thickener becomes smooth and homogeneous.

As used herein, the term “smooth” means having an even and regular surface or consistency; free from perceptible projections, lumps, or indentations.

In one embodiment, the method of making pudding comprises Combining Milled Buckwheat with Thickener at a temperature of above about 40° C. In another embodiment, the method of making pudding comprises Combining Milled Buckwheat with Thickener at a temperature of above about 50° C.

Also disclosed herein is a method of making a stable pudding composition, comprising heating an aqueous mixture of Milled Buckwheat in water; heating Thickener in water; Combining Milled Buckwheat with Thickener; Blending; Dispensing pudding into oxygen impermeable containers; and Sealing the oxygen impermeable containers.

As used herein, the term “Dispensing” means to distribute a specific amount of product into a predefined enclosed space, for example into a container, such as a plastic container.

In one embodiment, the method of making a stable pudding composition comprises Dispensing pudding at a temperature of about 30 to 40° C.

Also disclosed herein is a product produced by Heating an aqueous mixture of Milled Buckwheat in water, Heating Thickener in water, Combining Milled Buckwheat with Thickener, and Blending. In one embodiment, the product produced by this process comprises Flavoring Agents.

In one embodiment, the product produced by this process comprises Combining Milled Buckwheat with Thickener at a temperature of greater than 50° C.

In one embodiment, the product produced by this process comprises Heating an aqueous mixture of Milled Buckwheat in water at a temperature of about 100° C. for a time of about 15 to 25 minutes.

In one embodiment, the product produced by this process comprises a phenolic compound. As used herein, the term “phenolic compound” means a chemical compound consisting of a hydroxyl group (—OH) bonded directly to an aromatic hydrocarbon group.

In one embodiment, the product produced by this process comprises a compound chosen from Flavanoids, Flavanols, and Flavonols. As used herein, the term “Flavonoids” means a class of plant secondary metabolites derived from 2-phenylchromen-4-one (2-phenyl-1,4-benzopyrone) structure (for example quercetin, rutin). In some instances, these molecules are referred to as “vitamin P”.

As used herein, the term “Flavanols” means a set of compounds based on the flavonoid “flavans” which include Catechins.

As used herein, the term “Flavonols” means ketone-less flavonoids which include Rutin, Quercetin, and Hyperin.

In one embodiment, the product produced by this process comprises a compound chosen from rutin, quercetin, hyperon, or catechins. As used herein the term “rutin” means 2-(3,4-dihydroxyphenyl)-5,7-dihydroxy-3-[α-L-rhamnopyranosyl-(1→6)-β-D-glucopyranosyloxy]-4H-chromen-4-one.

As used herein the term “quercetin” means 2-(3,4-dihydroxyphenyl)-3,5,7-trihydroxy-4H-chromen-4-one.

As used herein the term “hyperin” means: 2-(3,4-dihydroxyphenyl)-3-[(3R,4S,5R,6R)-3,4,5-trihydroxy-6-(hydroxymethyl)oxan-2-yl]oxy-4H-chromene-4,5,7-triol.

As used herein, Flavan-3-ols (sometimes referred to as flavanols) mean derivatives of flavans that use the 2-phenyl-3,4-dihydro-2H-chromen-3-ol skeleton. These compounds include catechin, epicatechin gallate, epigallocatechin, epigallocatechin gallate, proanthocyanidins, theaflavins, thearubigins.

Various modifications of this disclosure, in addition to those shown and described herein, will become apparent to those skilled in the art from the following examples and the foregoing description. Such modifications are also intended to fall within the scope of the present disclosure.

### EXAMPLES

The following examples are intended to illustrate but not limit the above described invention. In each of the examples below, the following general procedures were applied:

Separately prepare Cooked Buckwheat by mixing 1 part buckwheat with 5 parts water and boiling the resulting mixture for 20 minutes.

Separately prepare Arrowroot custard by mixing 1 part arrowroot starch custard with 24 parts of boiling water and stir until mixture becomes thick and visually clear.

After separately preparing the Cooked Buckwheat and Arrowroot custard, combine these ingredients with the remaining ingredients in a Robot coupe 45 qt mixer pot.

Turn mixer on to speed II and blend for 6 minutes 30 seconds.

Transfer product into the prepared clean bucket. Load product into the assembled filling machine. Prime filling machine and adjust to 5.1 oz filling weight. Transfer mixture into the dedicated refrigerator for cooling to 90-95° F. Fill containers while composition is at 90-95 degrees ° F. Affix lid to containers. Transfer sealed containers to refrigerator.

### Example 1: Dark Dark Chocolate Pudding Buckwheat Pudding

### Ingredient 1: Arrowroot Custard

Ingredients

| | | |
|---|---|---|
| Arrowroot Starch | 321.96 | g |
| Water | 7.73 | l |

| | |
|---|---|
| Total Ingredient Weight | 17 lbs 11.92 oz |

### Ingredient 2: Cooked Buckwheat

Ingredients

| | |
|---|---|
| Cream Of Buckwheat | 1 kg 341.48 g |
| Water | 6.71 l |
| Total Ingredient Weight | 17 lbs 11.92 oz |

### Preparation of Dark Dark Chocolate Buckwheat Pudding

Ingredients

| | | |
|---|---|---|
| Arrowroot Custard | 8 kg 48.89 | g |
| Cooked Buckwheat | 8 kg 48.89 | g |
| Coconut Oil | 416.32 | g |
| Madagascar Vanilla Extract | 97.14 | g |
| Natural Cocoa Powder | 1 kg 248.97 | g |
| Salt | 41.63 | g |
| Sucanat | 1 kg 942.83 | g |

| | |
|---|---|
| Total Ingredient Weight | 43 lbs 12 oz |

### Example 2:“Nomilk” Chocolate Buckwheat Pudding

### Ingredient 1: Arrowroot Custard

Ingredients

| | | |
|---|---|---|
| Arrowroot Starch | 245.02 | g |
| Water | 5.88 | l |

| | |
|---|---|
| Total Ingredient Weight | 13 lbs 8.07 oz |

### Ingredient 2: Cooked Buckwheat

Ingredients

| | |
|---|---|
| Cream Of Buckwheat | 1 kg 132.29 g |
| Water | 5.66 l |
| Total Ingredient Weight | 14 lbs 15.64 oz |

### Preparation of “Nomilk” Chocolate Buckwheat Pudding

Ingredients

| | | |
|---|---|---|
| Arrowroot Custard | 6 kg 125.52 | g |
| Cooked Buckwheat | 6 kg 793.76 | g |
| Coconut Oil | 334.12 | g |
| Organic Jasmine Flavor | 0.01 | g |
| Madagascar Vanilla Extract | 77.96 | g |
| Natural Cocoa Powder | 668.24 | g |
| Salt | 33.41 | g |
| Sucanat | 1 kg 559.22 | g |

| | |
|---|---|
| Total Ingredient Weight | 34 lbs 6 oz |

### Example 3: Toasted Pistachio Tea Rose Buckwheat Pudding

### Ingredient 1: Arrowroot Custard

Ingredients

| | | |
|---|---|---|
| Arrowroot Starch | 117.96 | g |
| Water | 2.83 | l |

| | |
|---|---|
| Total Ingredient Weight | 6 lbs 8.03 oz |

### Ingredient 2: Cooked Buckwheat

Ingredients

| | | |
|---|---|---|
| Cream Of Buckwheat | 702.92 | g |
| Water | 3.51 | l |

| | |
|---|---|
| Total Ingredient Weight | 9 lbs 4.77 oz |

### Preparation of Toasted Pistachio Tea Rose Buckwheat Pudding

Ingredients

| Arrowroot Custard | 2 kg 949.11 | g |
|---|---|---|
| Cooked Buckwheat | 4 kg 217.55 | g |
| Coconut Oil | 158.55 | g |
| Pistashios Roasted Unsalted Gf | 380.53 | g |
| Rose Water | 19.03 | g |
| Salt | 19.03 | g |
| Sucanat | 761.06 | g |

| | |
|---|---|
| Total Ingredient Weight | 18 lbs 12 oz |

### Example 4: Vanilla Bean Cashew Buckwheat Pudding

### Ingredient 1: Arrowroot Custard

Ingredients

| | | |
|---|---|---|
| Arrowroot Starch | 177.98 | g |
| Water | 4.27 | l |

| | |
|---|---|
| Total Ingredient Weight | 9 lbs 12.95 oz |

### Ingredient 2: Cooked Buckwheat

Ingredients

| | |
|---|---|
| Cream Of Buckwheat | 1 kg 47.67 g |
| Water | 5.24 l |
| Total Ingredient Weight | 13 lbs 13.73 oz |

### Preparation of Vanilla Bean Cashew Buckwheat Pudding

Ingredients

| Arrowroot Custard | 4 kg 449.47 | g |
|---|---|---|
| Cooked Buckwheat | 6 kg 286.05 | g |
| Cashew Nuts | 571.22 | g |
| Coconut Oil | 260.51 | g |
| Salt | 28.56 | g |
| Sucanat | 1 kg 142.44 | g |
| Vanilla Beans | 19.04 | g |

1. A pudding composition comprising:
Buckwheat; and
Thickener.

2. The composition of claim 1, comprising Milled Buckwheat.

3. The composition of claim 2, comprising cooked Milled Buckwheat.

4. The composition of claim 1, wherein the Thickener is chosen from gum acacia and xanthan gum.

5. The composition of claim 1, comprising phenylalanine, valine, threonine, tryptophan, isoleucine, methionine, leucine, lysine, and histidine.

6. The composition of claim 1, comprising Salicylaldehyde (2-hydroxybenzaldehyde); 2,5-dimethyl-4-hydroxy-3(2H)-furanone; (E, E)-2,4-decadienal, phenylacetaldehyde, 2-methoxy-4-vinylphenol; (E)-2-nonenal; decanal; and hexanal.

7. The composition of claim 1, comprising at least one compound chosen from Fagopyritol A1, Fagopyritol A2, Fagopyritol B1, Fagopyritol B2, and Fagopyritol B3.

8. The composition of claim 1, wherein the Thickener is starch.

9. The composition of claim 8, wherein the starch is arrowroot starch.

10. The composition of claim 1, comprising coconut oil.

11. The composition of claim 1, wherein the composition is substantially free from gluten.

12. The composition of claim 1, wherein the composition is substantially free from dairy.

13. The composition of claim 1, wherein the composition is substantially free from animal-derived substances.

14. The composition of claim 1, wherein the composition is substantially free from soy.

15. The composition of claim 1, wherein the pudding composition is homogeneous.

16. The composition of claim 1, comprising sugar.

17. The composition of claim 16, wherein the sugar comprises a mineral chosen from calcium, magnesium, potassium, and iron.

18. A method of making pudding comprising:
heating an aqueous mixture of Milled Buckwheat in water;
heating Thickener in water;
Combining Milled Buckwheat with Thickener; and
Blending.

19. (canceled)

20. A product produced by
Heating an aqueous mixture of Milled Buckwheat in water;
Heating Thickener in water;
Combining Milled Buckwheat with Thickener; and
Blending.
